(19) United States
(12) Patent Application Publication
(10) Pub. No.: US 2018/0179791 A1
(43) Pub. Date: Jun. 28, 2018

(54) INSIDE HANDLE FOR VEHICLE DOOR

(71) Applicant: AISIN SEIKI KABUSHIKI KAISHA, Kariya-shi (JP)

(72) Inventors: Atsushi KAMIYA, Kariya-shi (JP); Yukinobu KUNIMATSU, Matsuyama-shi (JP)

(73) Assignee: AISIN SEIKI KABUSHIKI KAISHA, Kariya-shi (JP)

(21) Appl. No.: 15/739,802

(22) PCT Filed: Mar. 14, 2016
(86) PCT No.: PCT/JP2016/057990

§ 371 Date: Dec. 26, 2017

(30) Foreign Application Priority Data
Jun. 29, 2015 (JP) 2015-129587

(51) Int. Cl. E05B 85/12; E05B 79/06

(52) U.S. Cl. CPC E05B 85/12; B60J 5/04; E05B 79/06

(57) ABSTRACT

An inside handle for a vehicle door is provided. The inside handle includes a handle main body which is made of a resin, and the plating portion covering a surface of the handle main body. The inside handle further includes a vehicle interior side design surface, a vehicle exterior side design surface, a recessed portion, and a reinforcing rib. The recessed portion is formed in a recessed-portion formation surface forming one of an upper surface and a lower surface of the inside handle, and is positioned between a rotation center of the handle main body and a distal end portion of the inside handle. The reinforcing rib is provided inside the recessed portion, extends in a direction of connecting the vehicle interior side design surface and the vehicle exterior side design surface to each other, and has both end portions connected to an inner surface of the recessed portion.

### TECHNICAL FIELD

The present invention relates to an inside handle for a vehicle door.

### BACKGROUND ART

FIG. 8 is an illustration of an inside handle 100 which is to be supported rotatably on a vehicle interior side surface of a vehicle door, The inside handle 100 includes a rotation center 101. The rotation center 101 has an axis which is to be oriented in a vertical direction when the inside handle 100 is mounted to the vehicle door. That is, the inside handle 100 is supported on the vehicle door so as to be rotatable about the rotation center 101.

When the inside handle 100 is rotated about the rotation center 101 with respect to the vehicle door, a locking device built in the vehicle door is brought into an unlatched state (state under which the vehicle door can be opened with respect to a vehicle body).

The inside handle 100 has a structure in which a surface of a handle main body made of a resin is covered with a plating portion made of a metal.

The inside handle 100 includes a vehicle interior side design surface 102, a vehicle exterior side design surface 103, and a bottom-surface forming surface 104. The vehicle interior side design surface 102 forms a vehicle interior side surface when the inside handle 100 is mounted to the vehicle door. The vehicle exterior side design surface 103 forms a vehicle exterior side surface when the inside handle 100 is mounted to the vehicle door. The bottom-surface forming surface 104 forms a bottom surface when the inside handle 100 is mounted to the vehicle door.

As illustrated in FIG. 8, a recessed portion 105 having an approximately triangular shape is formed in the bottom-surface forming surface 104 of the inside handle 100. As illustrated, an inner surface of the recessed portion 105 on a side closer to the vehicle interior side design surface 102 has a shape extending along a side edge portion of the bottom forming surface 104 on a side closer to the vehicle interior side surface 102. Meanwhile, an inner surface of the recessed portion 105 on a side closer to the vehicle exterior side design surface 103 has a shape extending along a side edge portion of the bottom forming surface 104 on a side closer to the vehicle exterior side design surface 103. Further, portions positioned on both sides of the recessed portion 105 of the inside handle 100 respectively form small-thickness portions 106 and 107 extending in a longitudinal direction of the inside handle 100. An end portion of the inner surface of the recessed portion 105 on the side closer to the vehicle interior side design surface 102 and an end portion of the inner surface of the recessed portion 105 on the side closer to the vehicle exterior side design surface 103, which are positioned on a side closer to a distal end of the inside handle 100, are connected to each other. That is, the inside handle 100 has a connection region 108 in which one end portion of the small-thickness portion 106 and one end portion of the small-thickness portion 107 are connected to each other.

The recessed portion 105 is formed at the time of molding of the handle main body using the resin material. The recessed portion 105 contributes to weight reduction of the inside handle 100 and prevention of formation of a sink mark at the time of molding of the handle main body.

### CITATION LIST

### Patent Literature

[PTL 1] JP 2008-38378 A

### SUMMARY OF INVENTION

### Technical Problem

The handle main body made of the resin thermally expands at a high temperature. Therefore, when the two small-thickness portions 106 and 107 thermally expand due to an increase in temperature of the inside handle 100 after manufacture, the small-thickness portions 106 and 107 are sometimes distorted (deformed) in a direction of separating from each other with respect to the connection region 108 as a center, as indicated by the arrows in FIG. 8.

When the small-thickness portions 106 and 107 thermally expand in such a manner, there is a fear that large distortion may occur in the connection region 108 of the inside handle 100.

As a result, a stress caused by the large distortion may be generated in the connection region 108, and there is a possibility that, when the stress exceeds an allowable stress for the plating portion, a large crack is formed in the plating portion on the connection region 108. When the large crack is formed, there is a fear that the crack extends to the vehicle interior side design surface 102 and/or the vehicle exterior side design surface 103, which are liable to fall within a field of view of a passenger of a vehicle.

Therefore, hitherto, the plating portion is formed to have a large thickness. In this manner, even when the large stress is generated in the connection region 108 due to the increase in temperature of the inside handle 100, the large crack is less liable to be formed in the plating portion on the connection region 108 due to the stress. As a result, the crack formed in the connection region 108 is less liable to extend to the vehicle interior side design surface 102 and/or the vehicle exterior side design surface 103.

When the plating portion is formed to have a large thickness, however, manufacturing cost of the inside handle 100 is disadvantageously increased.

The present invention has an object to provide an inside handle for a vehicle door, which is capable of effectively preventing formation of a crack in plating portion on a vehicle exterior side design surface and/or a vehicle interior side design surface due to an increase in temperature of the inside handle without increasing a thickness of the plating portion.

### Solution to Problem

According to one embodiment of the present invention, there is provided an inside handle for a vehicle door, including: a handle main body, which is made of a resin, and is supported rotatably on a vehicle interior side surface of a vehicle door so as to operate a locking device provided to the vehicle door; a plating portion covering a surface of the handle main body, a vehicle interior side design surface configured to form a vehicle interior side surface of the handle main body when the inside handle is mounted to the vehicle body; a vehicle exterior side design surface configured to form a vehicle exterior side surface of the handle main body when the inside handle is mounted to the vehicle door; a recessed portion, which is positioned between a rotation center of the handle main body and a distal end portion of the inside handle, and is formed in a recessed-portion formation surface forming one of an upper surface and a lower surface of the handle main body when the inside handle is mounted to the vehicle door; and a reinforcing rib, which is provided inside the recessed portion, extends in a direction of connecting the vehicle interior side design surface and the vehicle exterior side design surface to each other, and has both end portions connected to an inner surface of the recessed portion.

The reinforcing rib is provided inside the recessed portion of the inside handle according to the present invention. The reinforcing rib extends in the direction of connecting the vehicle interior side design surface and the vehicle exterior side design surface of the inside handle to each other. Further, the both end portions of the reinforcing rib are connected to the inner surface of the recessed portion.

Therefore, even when two portions, that is, a portion positioned between the vehicle interior side design surface and the recessed portion and a portion positioned between the vehicle exterior side design surface and the recessed portion thermally expand due to an increase in temperature of the inside handle after manufacture, the two portions can be prevented from being largely distorted in a direction of separating from each other. Therefore, a connection region which forms a part of the inside handle and connects end portions of the two portions can be prevented from being largely distorted.

Thus, generation of a large stress in the plating portion on the connection region can be prevented. Therefore, formation of a large crack in the plating portion on the connection region due to the stress and extension of the crack to the vehicle exterior side design surface or the vehicle interior side design surface can be effectively prevented.

The recessed portion includes: a vehicle interior side inner surface, which forms a portion of the inner surface of the recessed portion on a side closer to the vehicle interior side design surface, and extends along a side edge portion of the recessed-portion formation surface on a side closer to the vehicle interior side design surface; and a vehicle exterior side inner surface, which forms a portion of the inner surface of the recessed portion on a side closer to the vehicle exterior side design surface, and extends along a side edge portion of the recessed-portion formation surface on a side closer to the vehicle exterior side design surface, in which an end portion of the vehicle interior side inner surface and an end portion of the vehicle exterior side inner surface, which are positioned on a side closer to the distal end portion of the inside handle, intersect with each other, and in which a distance between the vehicle interior side inner surface and the vehicle exterior side inner surface may gradually decrease in a direction from the rotation center to the distal end portion of the inside handle.

An end surface of the reinforcing rib on a side closer to the recessed-portion formation surface may be positioned on a side closer to a bottom portion of the recessed portion with respect to the recessed-portion formation surface.

When the inside handle thermally expands due to the increase in temperature of the inside handle after manufacture, the stress is liable to be larger in connecting portions between the reinforcing rib and the inner surface of the recessed portion than in peripheral portions thereof. Therefore, there is a possibility of formation of a (small) crack in the plating portion on the connecting portions (however, the possibility of occurrence of such an event is lower than a possibility that the crack extends to a region of the plating portion, which covers the vehicle exterior side design surface and the vehicle interior side design surface, due to occurrence of the distortion in the connection region adjacent to the two portions, that is, a portion positioned between the vehicle interior side design surface and the recessed portion and a portion positioned between the vehicle exterior side design surface and the recessed portion when the reinforcing rib is not provided).

However, the connecting portions between the reinforcing rib and the inner surface of the recessed portion are positioned on the side closer to the bottom portion of the recessed portion with respect to the recessed-portion formation surface. That is, distances from the connecting portions to the vehicle exterior side design surface and the vehicle interior side design surface on a surface of the inside handle are larger than those in a case in which the connecting portions are located at the same position as the recessed-portion formed surface. Therefore, the possibility that the crack may extend to a region of the plating portion, which covers the vehicle exterior side design surface and/or the vehicle interior side design surface, becomes lower than that in a case in which the connecting portions are located at the same position as the recessed-surface formed surface.

Further, the connecting portions (reinforcing rib) are positioned on the side closer to the bottom portion of the recessed portion with respect to the recessed-portion formation surface. Therefore, even when the crack is formed in the plating portion on the connecting portions, a possibility that the crack falls within a field of view of a passenger is not high.

The recessed portion has a polygonal shape having a plurality of corner portions, and the recessed portion may have a level-difference portion positioned on a side closer to a bottom portion of the recessed portion with respect to the recessed-portion formation surface at portions forming the corner portions in a peripheral edge portion of an end portion of the recessed portion on a side closer to the recessed-portion formation surface.

The “polygonal shape” includes an approximate polygonal shape.

When the inside handle thermally expands due to the increase in temperature after manufacture, the stress is liable to be larger at the corner portions than in peripheral portions. However, the stress is liable to become further larger in the level-difference portion at the corner portion than in a portion at the corner portion where the level-difference portion is not formed. Therefore, when the crack is formed in the plating portion on the corner portion, there is a high possibility of formation of a (small) crack in the level-difference portion.

However, the level-difference portion is positioned on the side closer to the bottom portion of the recessed portion with respect to the recessed-portion formation surface. That is, a distance from the level-difference portion to the vehicle exterior side design surface and/or the vehicle interior side design surface is larger than a distance from the recessed-portion formation surface to the vehicle exterior side design surface and/or the vehicle interior side design surface on the surface of the inside handle. Therefore, the possibility that the crack formed in the plating portion on the level-difference portion extends to the region of the plating portion, which covers the vehicle exterior side design surface and the vehicle interior side design surface, becomes lower than that in a case in which the crack is formed in the plating portion on the corner portions in the vicinity of the recessed-portion formation surface when the level-difference portion is not formed.

Further, the level-difference portion is positioned on the side closer to the bottom portion of the recessed portion with respect to the recessed-portion formation surface. Therefore, even when the crack is formed in the plating portion on the level-difference portion, the possibility that the crack falls within the field of view of the passenger is not high.

The level-difference portion may be formed over the entire peripheral edge portion of the recessed portion.

When the level-difference portion is formed only at the corner portions, the stress is increased at both end portions of the level-difference portion when the inside handle thermally expands. As a result, the crack is liable to be formed in the plating portion on the both end portions of the level-difference portion.

When the level difference portion is formed over the entire peripheral edge portion of the recessed portion, that is, when the recessed portion has an annular shape, however, there is no fear of occurrence of such inconvenience.

### BRIEF DESCRIPTION OF DRAWINGS

FIG. 1 is a schematic side view of a vehicle door including an inside handle according to a first embodiment of the present invention as viewed from a vehicle interior side.

FIG. 2 is a side view of the inside handle.

FIG. 3 is a bottom view of the inside handle.

FIG. 4 is a schematic sectional view taken along the arrow line IV-IV of FIG. 3.

FIG. 5 is a bottom view of an inside handle according to a second embodiment of the present invention.

FIG. 6 is a sectional view taken along the arrow line VI-VI of FIG. 5.

FIG. 7 is a sectional view according to a comparative example, corresponding to FIG. 6.

FIG. 8 is a bottom view of a related-art inside handle.

### DESCRIPTION OF EMBODIMENTS

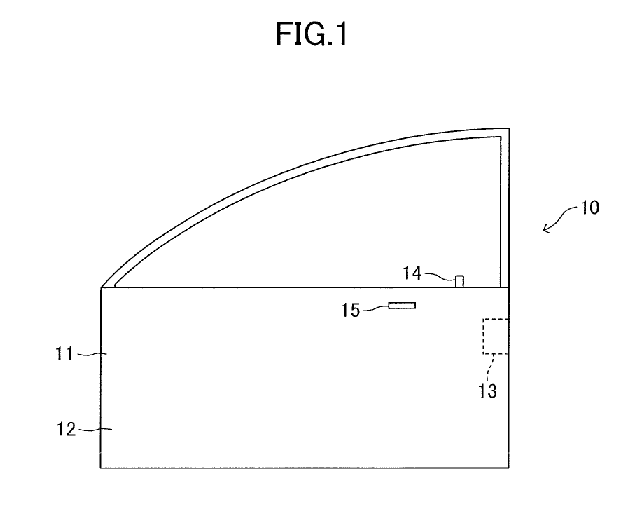

Now, a first embodiment of the present invention is described with reference to FIG. 1 to FIG. 4.

A vehicle door 10 illustrated in FIG. 1 is supported by a vehicle body (not shown) so as to be rotatable about a vertical axis of rotation, and can open and close an opening formed in a side surface of the vehicle body.

A vehicle interior side surface of a door main body portion 11 which constructs a lower half portion of the vehicle door 10 is formed of a trim 12 made of a resin.

Inside the vehicle door 10, a locking device 13 which is partially exposed on a rear end surface of the vehicle door 10 is provided. The locking device 13 has a well-known structure including a latch and a pawl. The locking device 13 is interconnected to a lock knob 14 which is provided to an upper end surface of the trim 12 so as to be freely slidable in the vertical direction. Further, the locking device 13 is interconnected to an inside handle 15 supported rotatably on the trim 12 through intermediation of an operating wire (not shown). The lock knob 14 is not required to be provided on the upper end surface of the trim 12 and may be built in, for example, the inside handle 15.

As is well known, when the lock knob 14 is positioned in a locking position (not shown) while the vehicle door 10 is in a state of closing the opening of the vehicle body, a latched state in which the latch of the locking device 13 holds a striker (not shown) fixed to the vehicle body is achieved. In this case, even when the inside handle 15 is operated to rotate from an initial position (non-operated position), the latch maintains the latched state. Meanwhile, in a case in which the lock knob 14 is positioned in an unlocking position (position illustrated in FIG. 1), when the inside handle 15 is operated to rotate from the initial position to the vehicle interior side, an unlatched state in which the latch of the locking device 13 releases the striker is achieved. Therefore, the vehicle door 10 can be rotated in an opening direction with respect to the vehicle body.

Next, a specific structure of the inside handle 15 is described.

The inside handle 15 includes a handle main body 16 and a plating portion 17 (see FIG. 4). The handle main body 16 is made of a resin and forms an overall shape of the inside handle 15. The plating portion 17 is a thin film made of a metal and covers an entire surface of the handle main body 16. That is, the inside handle 15 is manufactured by forming the handle main body 16 by resin molding and then providing the plating portion 17 on the surface of the handle main body 16 after the shape of the handle main body 16 is fixed.

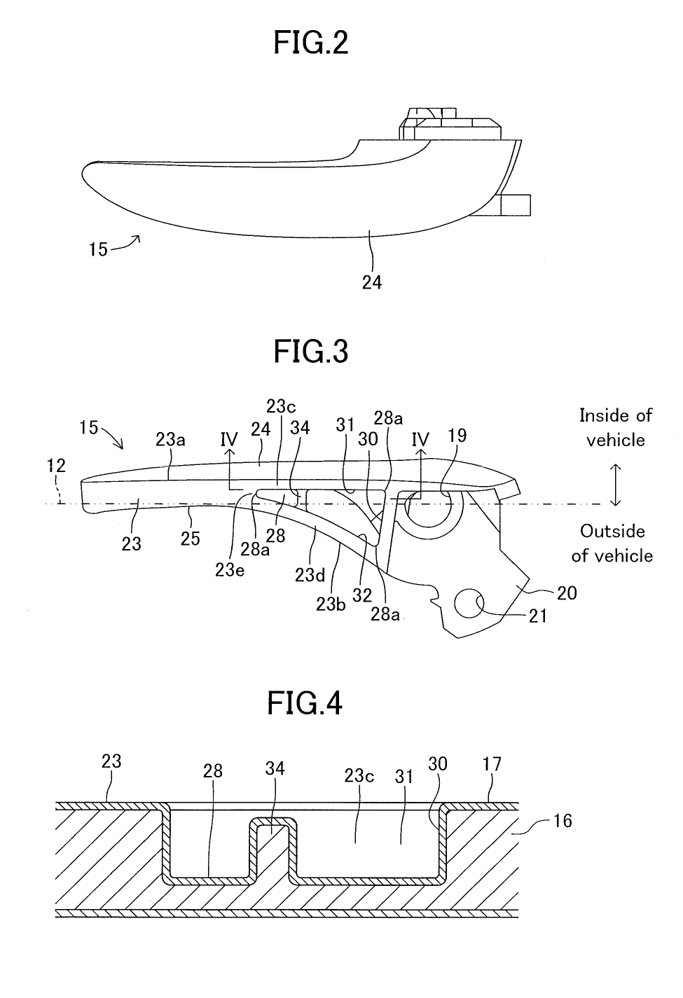

The inside handle 15 has the overall shape as illustrated in FIG. 2 and FIG. 3. That is, the inside handle 15 has an elongated shape.

In a vicinity of one longitudinal end portion of the inside handle 15, a rotation center 19 is formed. The rotation center 19 is a hole which linearly passes through the inside handle 15. An axial direction of the rotation center 19 is a direction which is oriented in the vertical direction when the inside handle 15 is mounted to the vehicle door 10. The inside handle 15 is mounted to the trim 12 under a state in which the rotation center 19 is rotatably fitted over a rotation shaft, which extends in the vertical direction, of a base frame (not shown) fixed to a door panel. A positional relationship between the trim 12 and the inside handle 15 when the inside handle 15 mounted to the trim 12 is positioned at the initial position is in a state as illustrated in FIG. 3. The rotation center of the inside handle 15 may be constructed by a shaft, and the shaft may be rotatably fitted into a hole formed in the base frame.

Further, an arm portion 20 is provided in a projecting manner to an end portion of the inside handle 15 on a side closer to the rotation center 19 A wire connection hole 21 being a through hole is formed in the arm portion 20. An axial direction of the wire connection hole 21 is parallel to the rotation center 19. The wire connection hole 21 is a hole to which one end of the above-mentioned operating wire is connected.

A surface of the inside handle 15, which forms a lower surface when the inside handle 15 is mounted to the vehicle door 10, is formed of a recessed-portion formation surface 23.

A surface of the inside handle 15, which forms a vehicle interior side surface when the inside handle 15 is mounted to the vehicle door 10, is formed of a vehicle interior side design surface 24 being a curved surface.

A surface of the inside handle 15, which forms a vehicle exterior side surface when the inside handle 15 is mounted to the vehicle door 10, is formed of a vehicle exterior side design surface 25 being a curved surface except for the arm portion 20.

The vehicle interior side design surface 24 falls within a field of view of a passenger of the vehicle when the inside handle 15 is mounted to the vehicle door 10 regardless of a rotational position of the inside handle 15 with respect to the vehicle door 10. Meanwhile, when the inside handle 15 is positioned at the initial position, the vehicle exterior side design surface 25 is positioned on a vehicle exterior side with respect to a vehicle interior surface side of the trim 12 and therefore does not fall within the field of view of the passenger. When the inside handle 15 is operated to rotate from the initial position to the vehicle interior side with respect to the trim 12, however, a part of the vehicle exterior side design surface 25 is moved to a position to fall within the field of view of the passenger.

A single recessed portion 28 is formed in the recessed-portion formation surface 23 of the inside handle 15.

The recessed portion 28 is recessed from the recessed-portion formation surface 23 toward a side of the inside handle 15 opposite to the recessed-portion formation surface 23 of the inside handle 15 (upper surface side of the inside handle 15 when the inside handle 15 is mounted to the vehicle door 10). A region of the recessed portion 28, which is positioned on the side opposite to the recessed-portion formation surface 23 (upper end portion when the inside handle 15 is mounted to the vehicle door 10), is closed. Further, the recessed portion 28 is formed between a distal end portion of the inside handle 15 and the rotation center 19.

A sectional shape of the recessed portion 28, that is, a shape taken along a plane orthogonal to the axis of the rotation center 19 is approximately triangular. In other words, an inner peripheral surface of the recessed portion 28 is formed of three portions. That is, the inner peripheral surface of the recessed portion 28 is formed of a rotation center-side surface 30, a vehicle interior side inner surface 31, and a vehicle exterior side inner surface 32. Portions at which the rotation center-side surface 30, the vehicle interior side inner surface 31, and the vehicle exterior side inner surface 32 intersect each other form three corner portions 28a.

The rotation center-side surface 30 is a surface forming a portion of the inner peripheral surface of the recessed portion 28, which is positioned closest to the rotation center 19.

The vehicle interior side inner surface 31 is a surface forming a portion of the inner peripheral surface of the recessed portion 28 on a side closer to the vehicle interior side design surface 24. As illustrated, when the inside handle 15 is viewed from the recessed-portion formation surface 23 side, the vehicle interior side inner surface 31 is approximately parallel to a side edge portion 23a of the recessed-portion formation surface 23 on a side closer to the vehicle interior side design surface 24. That is, when the inside handle 15 is viewed from the recessed-portion formation surface 23 side, the vehicle interior side inner surface 31 extends along the side edge portion 23a.

The vehicle exterior side inner surface 32 is a surface forming a portion of the inner peripheral surface of the recessed portion 28 on a side closer to the vehicle exterior side design surface 25. As illustrated, when the inside handle 15 is viewed from the recessed-portion formation surface 23 side, the vehicle exterior side inner surface 32 is approximately parallel to a side edge portion 23b of the recessed-portion formation surface 23 on a side closer to the vehicle exterior side design surface 25. That is, when the inside handle 15 is viewed from the recessed-portion formation surface 23 side, the vehicle exterior side inner surface 32 extends along the side edge portion 23b.

As illustrated, an end portion of the vehicle interior side inner surface 31 and an end portion of the vehicle exterior side inner surface 32, which are positioned on a side opposite to the rotation center 19, intersect with each other. Further, a distance between the vehicle interior side inner surface 31 and the vehicle exterior side inner surface 32 gradually decreases in a direction from the rotation center 19 to the distal end portion of the inside handle 15.

A portion of the inside handle 15 which is positioned between the side edge portion 23a (vehicle interior side design surface 24) and the recessed portion 28 (vehicle interior side inner surface 31) forms a small-thickness portion 23c extending in a longitudinal direction of the inside handle 15. A portion of the inside handle 15 which is positioned between the side edge portion 23b (vehicle exterior side design surface) and the recessed portion 28 (vehicle exterior side inner surface 32) forms a small-thickness portion 23d extending in a longitudinal direction of the inside handle 15. Further, the inside handle 15 includes a connection region 23e in which one end portion of the small-thickness portion 23c and one end portion of the small-thickness portion 23d (end portions on a side closer to the distal end of the inside handle 15) are connected to each other.

The inside handle 15 includes a reinforcing rib 34 provided inside the recessed portion 28.

The reinforcing rib 34 is a member extending in a direction of connecting the vehicle interior side inner surface 31 and the vehicle exterior side inner surface 32 when the inside handle 15 is viewed from the recessed-portion formation surface 23 and has both end portions connected to the vehicle interior side inner surface 31 (small-thickness portion 23c) and the vehicle exterior side inner surface 32 (small-thickness portion 23d), respectively.

Further, the reinforcing rib 34 is positioned not in a central portion of the recessed portion 28 but on a side slightly closer to the distal end of the inside handle 15 with respect to the central portion.

As illustrated in FIG. 4, an end surface of the reinforcing rib 34 on the side closer to the recessed-portion formation surface 23 is positioned on a side closer to a bottom portion of the recessed portion 28 with respect to the recessed-portion formation surface 23.

As described above, the handle main body 16 of the inside handle 15 is made of a resin. Therefore, when a temperature of the inside handle 15 is increased after manufacture, the handle main body 16 thermally expands. That is, as in the related art, when the temperature of the inside handle 15 is increased, the small-thickness portion 23c and the small-thickness portion 23d are liable to be distorted (deformed) in a direction of separating from each other about the connection region 23e as a center.

However, the inside handle 15 includes the reinforcing rib 34 configured to connect a portion of the vehicle interior side inner surface 31 (small-thickness portion 23c), which is positioned on the side closer to the distal end of the inside handle 15 with respect to a central portion of the vehicle interior side inner surface 31, and a portion of the vehicle exterior side inner surface 32 (small-thickness portion 23d), which is positioned on the side closer to the distal end of the inside handle 15 with respect to a central portion of the vehicle exterior side inner surface 32. Therefore, even when the small-thickness portion 23c and the small-thickness portion 23d thermally expand, the reinforcing rib 34 can prevent the small-thickness portion 23c and the small-thickness portion 23d from being largely distorted in the direction of separating from each other. Therefore, the connection region 23e of the inside handle 15 can be prevented from being largely distorted.

Therefore, even when the plating portion 17 is not formed to have a large thickness, generation of a large stress in the plating portion 17 on the connection region 23e can be suppressed. Thus, a large crack can be prevented from being formed in the plating portion 17 on the connection region 23e due to the stress, and the crack can also be effectively prevented from extending to a region which covers the vehicle interior side design surface 24 and the vehicle exterior side design surface 25, that is, a region which is liable to fall within the field of view of the passenger. In other words, a small stress is generated in the plating portion 17 on the connection region 23e. As a result, there is a possibility that a small crack may be formed in the plating portion 17 on the connection region 23e. However, the crack is small. Thus, there is a low possibility that the crack on the connection region 23e may extend to the vehicle interior side design surface 24 and/or the vehicle exterior side design surface 25.

Further, the connection region 23e is positioned on the lower surface side of the inside handle 15. Thus, even when the crack is formed in the plating portion 17 on the connection region 23e, there is little possibility that the crack may fall within the field of view of the passenger.

Further, when the inside handle 15 thermally expands due to the increase in temperature after manufacture, the stress is liable to be larger in a connecting portion between the vehicle interior side inner surface 31 (small-thickness portion 23c) and the reinforcing rib 34 and in a connecting portion between the vehicle exterior side inner surface 32 (small-thickness portion 23d) and the reinforcing rib 34 than in peripheral portions thereof. Therefore, there is a possibility that a (small) crack may be formed in the plating portion 17 on the connecting portions (however, the possibility of occurrence of such an event is lower than a possibility of formation of the crack in the surface plating portion 17 on the vehicle interior side design surface 24 and/or the vehicle exterior side design surface 25 due to occurrence of the distortion in the connection region 23e when the reinforcing rib 34 is not provided).

The connecting portion between the vehicle interior side inner surface 31 (small-thickness portion 23c) and the reinforcing rib 34 and the connecting portion between the vehicle exterior side inner surface 32 (small-thickness portion 23d) and the reinforcing rib 34 are positioned above the recessed-portion formation surface 23. That is, distances from the connecting portions to the vehicle interior side design surface 24 and the vehicle exterior side design surface 25 on the surface of the inside handle 15 are larger than those in a case in which the connecting portions are positioned at the same position as the recessed-portion formation surface 23. Therefore, the possibility that the crack may extend to the region of the plating portion 17, which covers the vehicle interior side design surface 24 and the vehicle exterior side design surface 25, is smaller than that in the case in which the connecting portions are positioned at the same position as the recessed-portion formation surface 23.

Further, the connecting portions are positioned on the side closer to the lower surface of the inside handle 15 and are positioned above the recessed-portion formation surface 23. Therefore, even when the crack is formed in the plating portion 17 on the connecting portions, there is little possibility that the crack may fall within the field of view of the passenger.

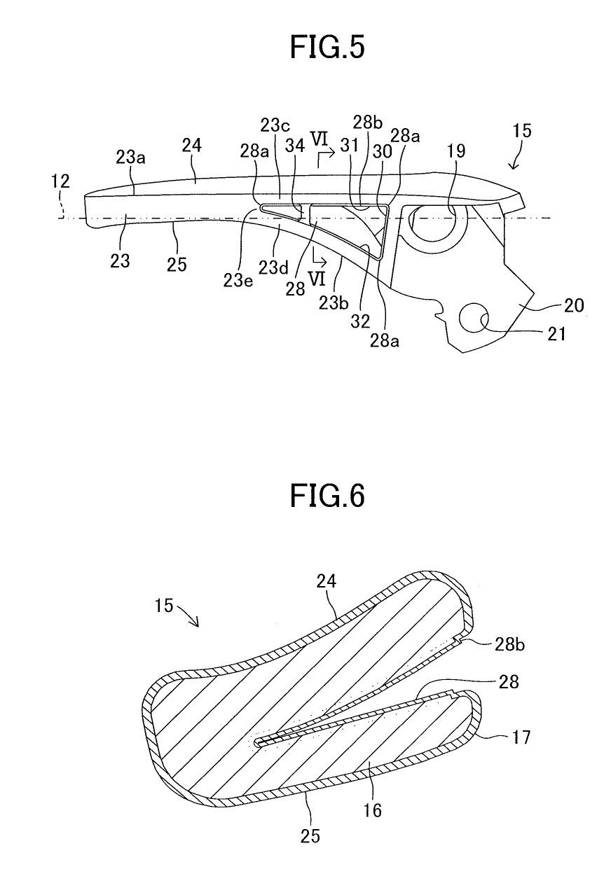

Next, a second embodiment of the present invention is described with reference to FIG. 5 to FIG. 7. The same members as those of the first embodiment are only denoted by the same reference symbols, and detailed description thereof is herein omitted.

A feature of the second embodiment lies in that a level-difference portion 28b which is recessed upward by one step from the recessed-portion formation surface 23 is formed in an entire peripheral edge portion of an end portion of the recessed portion 28 which is on a side closer to the recessed-portion formation surface 23. The level-difference portion 28b is positioned on the same plane as an end surface of the reinforcing rib 34 on the side closer to the recessed-portion formation surface 23, and is continuous with the end surface of the reinforcing rib 34 on the side closer to the recessed-portion formation surface 23.

When the inside handle 15 of the second embodiment thermally expands due to the increase in temperature after manufacture, the stress is liable to be larger at the three corner portions 28a of the recessed portion 28 than in the peripheral portions thereof. However, the stress is liable to be larger in the level-difference portion 28b at each corner portion 28a than in a portion of each corner portion 28a where the level-difference portion 28b is not formed. Therefore, a (small) crack is liable to be formed in the plating portion 17 on the level-difference portion 28b at each of the three corner portions 28a.

However, the level-difference portion 28b is positioned above the recessed-surface formation surface 23. That is, a distance from the level-difference portion 28b to the vehicle interior side design surface 24 on the surface of the inside handle 15 and/or a distance from the level-difference portion 28b to the vehicle exterior side design surface 25 on the surface of the inside handle 15 are larger than a distance from the recessed-portion formation surface 23 to the vehicle interior side design surface 24 and/or a distance from the recessed-portion formation surface 23 to the vehicle exterior side design surface 25. Therefore, the possibility that the crack formed in the plating portion 17 on the level-difference portion 28b provided at each of the corner portions 28a may extend to the region of the plating portion 17, which covers the vehicle interior side design surface 24 and the vehicle exterior side design surface 25, is lower than in a case in which the crack is formed at each of the corner portions 28a in the vicinity of the recessed-portion formation surface when the level-difference portion 28b is not provided.

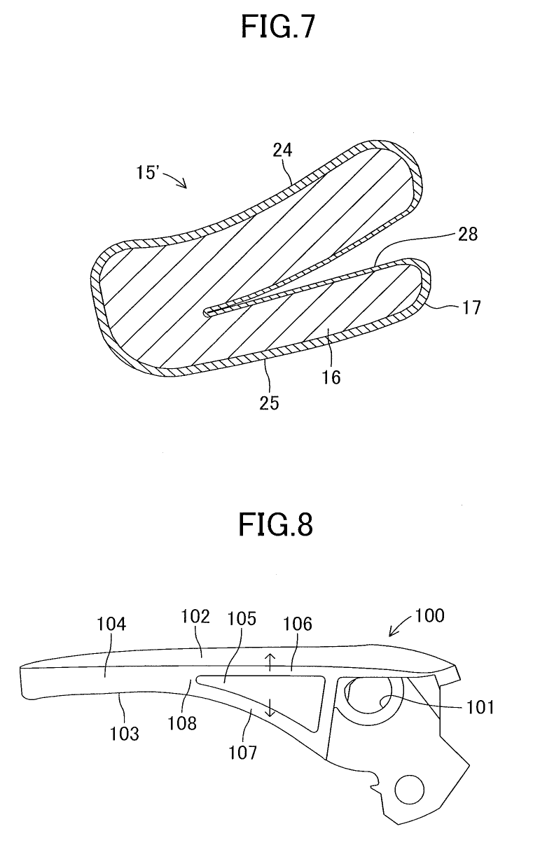

In an inside handle 15′ without the level-difference portion 28b according to a comparative example illustrated in FIG. 7, when the crack is formed in the plating portion 17 on a portion of the corner portion 28a which is close to the recessed-portion formation surface 23, there is a sufficiently high possibility that the crack may extend to the region of the plating portion 17, which covers the vehicle interior side design surface 24 and/or the vehicle exterior side design surface 25.

Further, when the level-difference portion 28 is formed only at the three corner portions 28a, that is, each of the level-difference portions 28b has both ends in an intermediate portion between the adjacent corner portions 28a, the stress at both end portions of each of the level-difference portions 28b is liable to be high when the inside handle 15 thermally expands. That is, the crack is liable to be formed in the plating portion 17 at the both end portions of each level-difference portion 28b.

In a case in which the level-difference portion 28b is formed over the entire peripheral edge of the end portion of the recessed portion 28 on the side closer to the recessed-portion formation surface 23, as in the second embodiment, that is, the recessed portion 28 has an annular shape, however, there is no fear of occurrence of such inconvenience.

Further, the level-difference portion 28b is positioned on the side closer to the lower surface of the inside handle 15 and is positioned above the recessed-portion formation surface 23. Therefore, even when the crack is generated in the plating portion 17 on the level-difference portion 28b, there is little possibility that the crack may fall within the field of view of the passenger.

The present invention is described above referring to the embodiments. However, the present invention is not limited to the above-mentioned embodiments.

For example, the sectional shape of the recessed portion 28 is not required to be an approximate triangle and may be an exact triangle. Further, the sectional shape of the recessed portion 28 may be polygonal (or the approximately polygonal) other than the triangle (and the approximate triangle). The term “polygonal” in the scope of claims includes not only an exact polygon (polygonal) but also an approximate polygon (polygonal) in its concept.

The end surface of the reinforcing rib 34 may be positioned at the same position as the recessed-portion formation surface 23.

Further, the recessed portion 28 (recessed-portion formation surface 23) may be formed on a side closer to the upper surface side (side opposite to the recessed-portion formation surface 23) of the inside handle 15.

A relative position of the reinforcing rib 34 inside (with respect to) the recessed portion 28 may be different from that of the embodiments described above.

In the second embodiment, the level-difference portion 28b may be provided only at a position corresponding to each of the corner portions 28a of the recessed portion 28.

1. An inside handle for a vehicle door, comprising:
a handle main body, which is made of a resin, and is supported rotatably on a vehicle interior side surface of a vehicle door so as to operate a locking device provided to the vehicle door;
a plating portion covering a surface of the handle main body;
a vehicle interior side design surface configured to form a vehicle interior side surface of the handle main body when the inside handle is mounted to the vehicle door;
a vehicle exterior side design surface configured to form a vehicle exterior side surface of the handle main body when the inside handle is mounted to the vehicle door;
a recessed portion, which is positioned between a rotation center of the handle main body and a distal end portion of the inside handle, and is formed in a recessed-portion formation surface forming one of an upper surface and a lower surface of the handle main body when the inside handle is mounted to the vehicle door; and
a reinforcing rib, which is provided inside the recessed portion, extends in a direction of connecting the vehicle interior side design surface and the vehicle exterior side design surface to each other, and has both end portions connected to an inner surface of the recessed portion.

2. The inside handle for a vehicle door according to claim 1,
wherein the recessed portion includes:
a vehicle interior side inner surface configured to form a portion of the inner surface of the recessed portion on a side closer to the vehicle interior side design surface, and to extend along a side edge portion of the recessed-portion formation surface on a side closer to the vehicle interior side design surface; and
a vehicle exterior side inner surface configured to form a portion of the inner surface of the recessed portion on a side closer to the vehicle exterior side design surface, and to extend along a side edge portion of the recessed-portion formation surface on a side closer to the vehicle exterior side design surface,
wherein an end portion of the vehicle interior side inner surface and an end portion of the vehicle exterior side inner surface, which are positioned on a side closer to the distal end portion of the inside handle, intersect with each other, and
wherein a distance between the vehicle interior side inner surface and the vehicle exterior side inner surface gradually decreases in a direction from the rotation center to the distal end portion of the inside handle.

3. The inside handle for a vehicle door according to claim 1, wherein an end surface of the reinforcing rib on a side closer to the recessed-portion formation surface is positioned on a side closer to a bottom portion of the recessed portion with respect to the recessed-portion formation surface.

4. The inside handle for a vehicle door according claim 1,
wherein the recessed portion has a polygonal shape having a plurality of corner portions, and
wherein the recessed portion has a level-difference portion positioned on a side closer to a bottom portion of the recessed portion with respect to the recessed-portion formation surface at portions forming the corner portions in a peripheral edge portion of an end portion of the recessed portion on a side closer to the recessed-portion formation surface.

5. The inside handle for a vehicle door according to claim 4, wherein the level-difference portion is formed over the entire peripheral edge portion of the recessed portion.
